(19) United States
(12) Patent Application Publication
(10) Pub. No.: US 2012/0323711 A1
(43) Pub. Date: Dec. 20, 2012

(54) VIRTUAL HYBRID PRINTER SYSTEM

(76) Inventors: Larry Fandel, Foothill Ranch, CA (US); John Crawley, Foothill Ranch, CA (US); Mina Lee, Foothill Ranch, CA (US); Dan Johnson, Foothill Ranch, CA (US); Howard Walter, Foothill Ranch, CA (US)

(21) Appl. No.: 13/164,465

(22) Filed: Jun. 20, 2011

(51) Int. Cl. G06Q 20/00; G06F 3/12

(52) U.S. Cl. 705/17; 358/1.6; 705/16

(57) ABSTRACT

A virtual hybrid printer that provides the capabilities and function of a physical hybrid printer with fewer physical devices. The virtual hybrid printer employs virtual controls for additional devices so that applications can directly employ the virtual hybrid printer in a manner that simulates all desired hybrid printer capabilities without the need for all physical devices corresponding to those capabilities.

### BACKGROUND

Point of sale systems (“POS”) can typically process various types of payment, including cash, debit card, credit card, gift cards, and checks. The architecture of point sale system can be implemented as guided by certain industry standards. An example of one standard is the UnifiedPOS Retail Peripheral Architecture, Version 1.12, Released Jul. 15, 2009 by the Association for Retail Technology Standards (ARTS) of the National Retail Federation (“UnifiedPOS”). The UnifiedPOS can be implemented in a number of architectures. For example, it can be implemented using OLE for Retail POS (OPOS) for Windows based systems, and Java for Retail POS (JavaPOS) for Windows, Linux, and other non-Windows based systems. To facilitate the description of embodiments of the invention, the terms “Control” and “Service” which are utilized in the OPOS and JavaPOS implementations are used to aid the discussion of the functional areas of the embodiments. The present invention is not limited to any particular architecture of any standard, and the references to the UnifiedPOS are an example to facilitate a background discussion and a discussion of embodiments of the present invention.

To make a purchase, one form of payment is a check. In the process of completing such a purchase transaction, an electronic system captures the bank account information and the amount of the check. Point of sale systems have used hybrid printers that have the capability to handle check processing. Some such printers are capable of capturing information by reading magnetic ink, and recognizing the characters printed in such ink on the check, so called magnetic ink character recognition (“MICR”). Some of these printers have included the capability: to allow for check endorsement (which includes printing of transaction information the back of a check), to print on the face of the check the payee (retailer's name), amount and date; and perform “check truncation” which converts a paper check into an electronic funds transfer transaction through image capture of the check. Due to the complex mechanical nature of such hybrid printers, they have and continue to be more expensive than single printers (which do not provide such check handling capabilities). Consequently, such printers readers are expensive, and add to the complexity and maintenance of the overall retail system.

Recently, consumer use of checks as a form of payment has begun to subside. The reduced volume of checks being processed, results in an increase in the unit cost of processing checks. This decline in check processing appears to coincide with a shift in consumers' preferences to use electronic banking services to present and pay a majority of their routine bills. Therefore, there is more a need to decrease the cost of point of sale systems, and in particular to reduce a retailer's cost of handling checks

### SUMMARY OF THE INVENTION

It is a general object of an embodiment of the present invention to an improved point of sale system.

It is a further object of an embodiment of the present invention to provide an improved point of sale hybrid printer.

It is another object of an embodiment of the present invention to provide a less expensive hybrid printer.

It is a further object of an embodiment of the present invention to provide a hybrid printer with fewer hardware subsystems.

It is a further object of an embodiment of the present invention to provide a Virtual Hybrid Printer System that incorporates a Receipt Printer, an Image Scanner, and a Control Unit with an application.

It is a further object of an embodiment of the present invention that the interfaces to the Receipt Printer and the Image Scanner are separate interfaces.

It is a further object of an embodiment of the present invention to incorporate a Receipt Printer, providing a way to print the transaction and image data on a receipt.

It is a further object of an embodiment of the present invention to incorporate an Image Scanner to capture image data.

It is a further object of an embodiment of the present invention to incorporate a Control Unit with an Application providing a way to create the combined virtual image data.

It is a further object of an embodiment of the present invention to incorporate a Receipt Printer providing a way of printing the virtual image data on a receipt.

It is a further object of an embodiment of the present invention to incorporate a Receipt Printer interface providing a way to capture data sent to the SLP printer and create a virtual image containing that data.

It is a further object of an embodiment of the present invention to incorporate a Receipt Printer interface providing a way of the creating a virtual receipt with the transaction data and the virtual image data on a receipt image.

It is a further object of an embodiment of the present invention to incorporate an Image Scanner providing a way to capture image data of a check payment.

It is a further object of an embodiment of the present invention to incorporate a Control Unit with an Application providing a way to capture specific information from the image data.

It is a further object of an embodiment of the present invention to incorporate a Control Unit with an Application providing a way to extract specific information from a check image. The said specific information is the MICR data.

It is a further object of an embodiment of the present invention to incorporate a Control Unit with an Application providing a way to verify if the captured information is correct.

It is a further object of an embodiment of the present invention to incorporate a Control Unit with an Application providing a way to send the transaction data and image data to the receipt printer.

It is a further object of an embodiment of the present invention to incorporate a Control Unit with an Application providing a way to endorse the virtual check image.

It is a further object of an embodiment of the present invention to incorporate a Control Unit with an Application providing a way to complete a transaction that used a check as the form of payment.

The above and other objects of an embodiment of the present invention can be met through, for example, a virtual hybrid printer operatively connectable for communications with an application, said virtual hybrid printer comprising: a control unit; a physical printer device operatively connected to the control unit and connectable to provide a receipt printing function for an application; a physical scanner device operatively connected to the control unit and connectable to provide a imaging function for an application; a virtual magnetic information character recognition service, operatively connectable for communications with an application, and for providing magnetic information character recognition data to the application based on an image from the physical scanner device.

As another example, the above and other objects of an embodiment of the present invention can be met through, for example a virtual hybrid printer image processing method comprising: scanning a customer signed check image via an image scanning device; creating virtual check image from the scanned check image; storing virtual check image in a storage media; extracting magnetic image character recognition data from the virtual check image; sending magnetic image character recognition data to a point of sale application; retrieving the virtual check image and adding endorsement to the virtual check image in accordance with commands from a point of sale application; retrieving completed virtual check image in accordance with commands from a point of sale application for an electronic funds transfer; retrieving completed virtual check image in accordance with commands from a point of sale application for printing on the receipt printer; and printing a receipt on a physical receipt printer.

### BRIEF DESCRIPTION OF THE DRAWINGS

FIG. 1 schematically illustrates point of sale system that includes a hybrid printer.

FIG. 2 schematically illustrates a point of sale system including an embodiment of the present invention.

FIG. 3 schematically illustrates a more detail view of a point of sale system including an embodiment of the present invention.

FIG. 3a schematically illustrates a more detail view of a point of sale system including an embodiment of the present invention with the use of a web camera or other imaging type of device that can capture check image data.

FIG. 4 illustrates an example of payment processing that can be utilized with the present invention.

FIG. 5 illustrates an example of payment processing with check truncation that can be utilized with the present invention.

FIG. 6 illustrates an example of payment processing including filling in a portion of check that can be utilized with the present invention.

FIG. 7 further illustrates an example of an embodiment of the present invention.

FIG. 8(a) illustrates an example image of a check.

FIG. 8(b) illustrates an example check endorsement image.

FIGS. 9(a), (b), (c) and (d) illustrates examples of hardware configurations for embodiments of the present invention.

FIG. 10 illustrates examples of hardware configurations for embodiments of the present invention that can include a camera.

### DESCRIPTION OF THE PREFERRED EMBODIMENTS

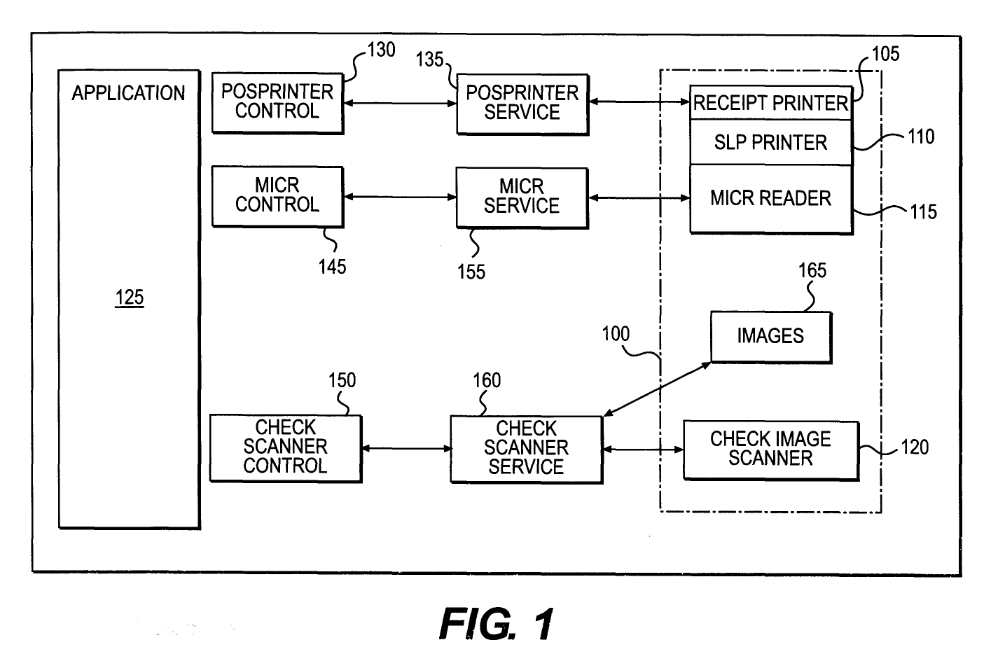

FIG. 1 schematically illustrates point of sale system that includes a hybrid printer, which is generally illustrated as 100. Referring to FIG. 1, the hybrid printer includes four hardware subsystems, a receipt printer 105, a slip printer (“SLP”) 110, a magnetic ink character recognition (“MICR”) 115, and a check image scanner 120. An application 125 can use the hybrid printer during the course of, for example, a consumer transaction. The application 120 interfaces with the hybrid printer via certain software and/or hardware. For example, the application 125 interfaces with the receipt printer 105 via, POSPrinter Control 130 and POSPrinter Service 135. The POSPrinter Control 130, or more generally control, provides the interface between the application 125 and the POSPrinter Service 135 so that the application 125 can communicate with the receipt printer 105. The POSPrinter control 130 implements the control functions for the receipt printer 105, such as starting the printer or sending information to be printed. The POSPrinter Service 135 interfaces with the POSPrinter Control 130 to implement the functionality of the receipt printer 105. The service can included device specific software and/or hardware to allow for the accessing, monitoring, processing and functionality of the device. This can be provided via a common interface to the application 125 so that the application can communicate, control and operate the device. The application 125 also interfaces with the SLP Printer 110 via the POSPrinter Control 130 and POSPrinter service 135 in a similar manner. Generally, in this exemplary embodiment, a Control provides a standard interface of commands (methods) and data (properties) to the POS application according to the UnifiedPOS standards. A Service implements these commands for the physical device, and manages data to and from the physical device.

FIG. 1 also illustrates the MICR 115 and Check Image Scanner 120 interfacing with the application 125 in a manner similar to that of the receipt printer 105, that is, via respective controls (145, 150) and services (155, 160). The images 165 are images optionally stored by the physical check scanner device, if the device includes this optional functionality. The images 365 are the images based on the output of the Check Scanner Device 120. In one exemplary embodiment, the images 365 can be stored and retrieved in accordance with the UnifiedPOS. The images 365 can be stored by, for example, the Virtual Check Scanner Control 315 for later use by the virtual MICR Service 340 to extract the MICR data, and by the Virtual SLP Service 330 to merge with the image of the endorsement text. The images 365 can be any storage media of the system or a separate storage media.

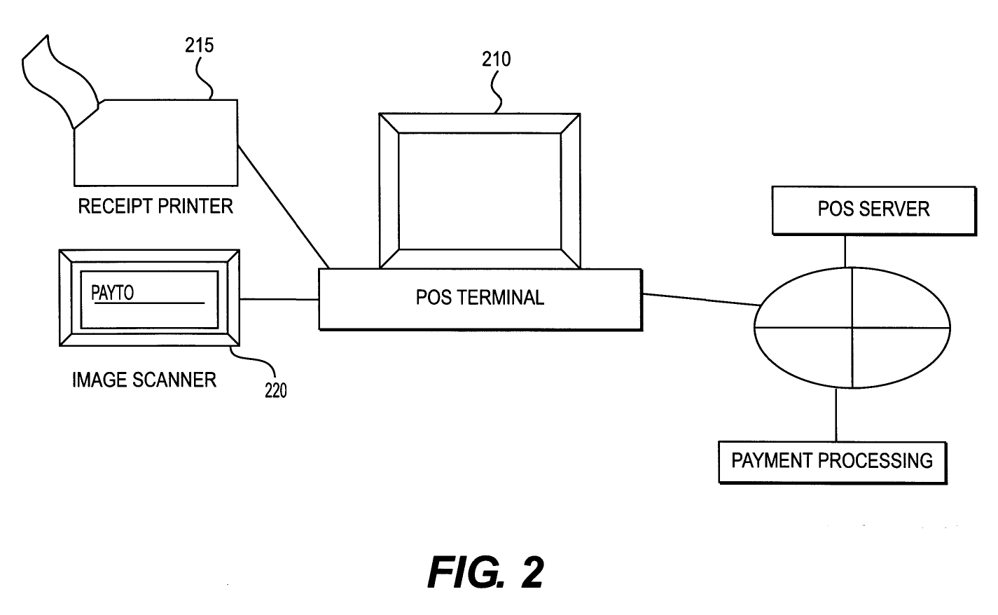

FIG. 2 schematically illustrates a point of sale system including an embodiment of the present invention. Referring to FIG. 2, a POS terminal 210 interfaces with a receipt printer 215 and an image scanner 220. This example system does not include either a MICR of a SLP Printer. It includes two hardware subsystems versus the four in the hybrid printer 100 of FIG. 1. As a result, the hardware and maintenance costs are reduced compared to the hybrid printer of FIG. 1, without, as explained more fully below, reducing the functionality.

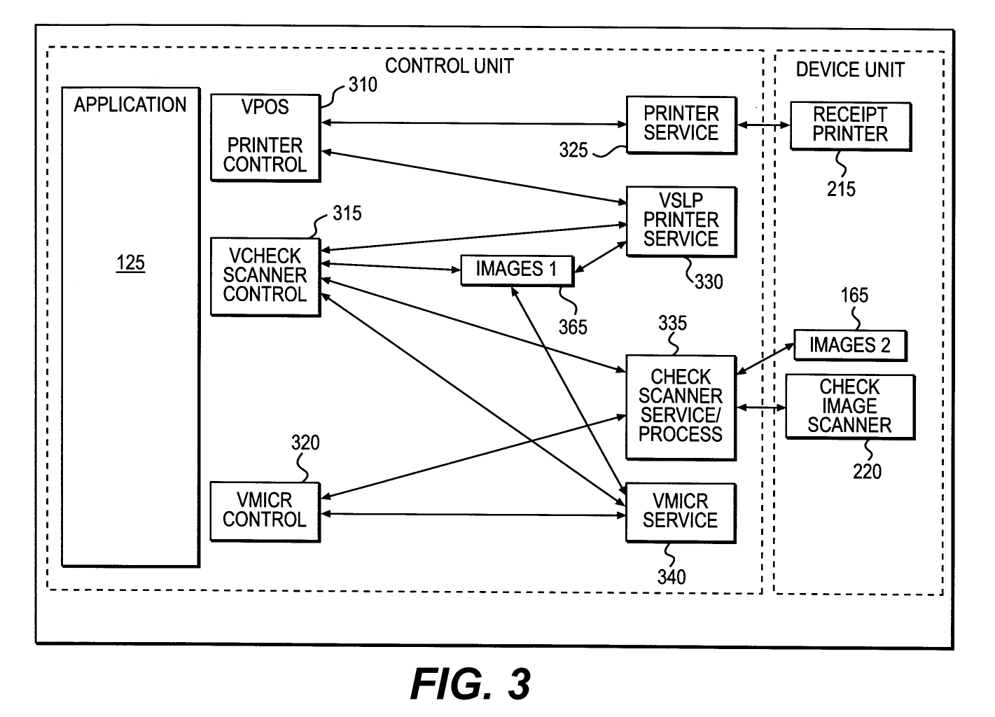

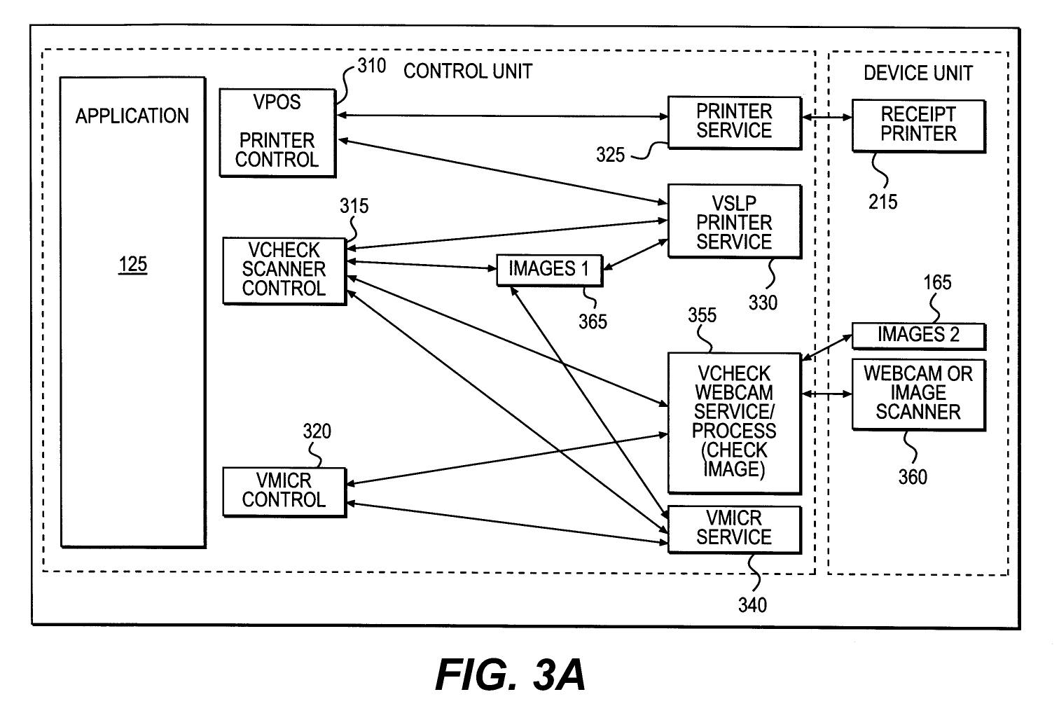

FIG. 3 schematically illustrates a more detail view of a point of sale system including an embodiment of the present invention. Similar to the FIG. 2 system, the FIG. 3 system includes two physical devices, a receipt printer 215 and a check image scanner 220. These two physical devices provide, in accordance with embodiments of the present, the capabilities of the four physical devices of FIG. 1. In the FIG. 3 embodiment, these capabilities are provided via three virtual controls, VPOS Printer Control 310, VCHECK Scanner Control, 315 and VMICR Control 320. In addition to the virtual controls, in the disclosed example, there are four services, VSLP Printer Service 330, VMICR Service 340, Check Scanner Service 335, and Printer Service 325 that provide the device specific capabilities. The FIG. 3 embodiment shows the VSLP Printer Service 330 and the VMICR Service 340 as separate entities. But, their functionality may reside in separate entities, or may reside in any or all of the virtual controls, or a combination of both. In the example embodiment of FIG. 3, the system, e.g., the virtual hybrid printer, utilizes modified UnifiedPOS architecture. The modified architecture replaces generic controls for the POS Printer, Check Scanner, and the MICR with virtual controls that provide the same interface to the application as the generic controls, but functionally achieve the operations of the hybrid printer.

As an example of the FIG. 3 operation, if the application 125 needs to access an MICR to obtain the MICR data from a check, the check image scanner 220 is activated and caused to capture an image of the check. In accordance with this embodiment of the present invention, the MICR data can be extracted from the image and returned to the application 125. The check image scanner 220 and MICR devices utilize a check image. The check image scanner 220 is commonly the only device that can capture a check image. If the application 125 requests the MICR data from a check, the VMICR service 340 activates the check image scanner device 220 via the VCHECK Scanner Control 315 and the Check Scanner Service 335 to obtain a check image from the check image scanner 220. The VCHECK Scanner Control 315 places the check image captured in images 365, where it can be available for the VMICR service 340 and the VSLP service 330. The VMICR Service 340 analyses the check image from images 365 to identify the MICR characters in the check image.

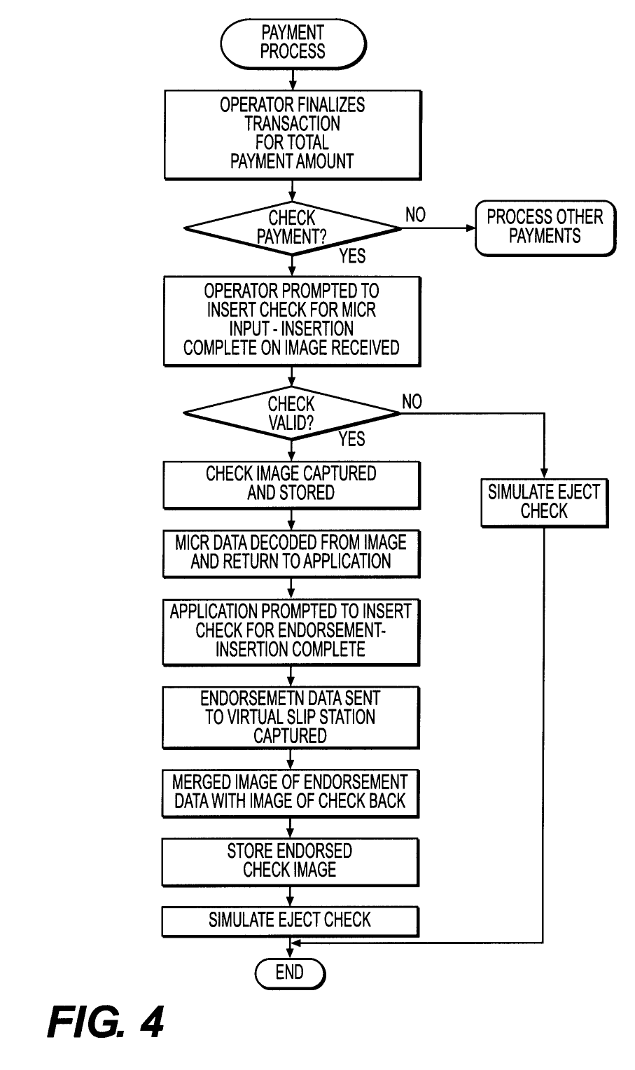

In accordance with the FIG. 3 embodiment, if the application 125 subsequently requests a check image to be captured, the check image scanner 220 will not require a second scan of the check. Instead, the image captured when the MICR data was processed, e.g., the image 365 will be returned. FIG. 5 illustrates an example of logical steps that an Application 125 can take to process a check payment where the MICR data, the original check image, and the endorsed check image are utilized. Another benefit that can be provided with the embodiment of FIG. 3 is that when the application 125 activates the slip printer to endorse a check, the check image scanner 220 does not require a second scan of the check. Again, the image captured when the MICR data was processed, e.g., the image will be returned, and in particular, the endorsing text image to be used with the image of the back of the check that was scanned to obtain the MICR data is returned by the Check image scanner device 220.

The following summarizes the operation of the FIG. 3 embodiment. The VPOS Printer Control 310 is a control that, in this embodiment, implements the UnifiedPOS. In this embodiment, the application 125 communicates in a standard manner with the receipt printer 215, however, some of the functions of a physical hybrid printer are implemented as virtual and not real printer functions, and some of the functions are implemented as real printer functions. For example, the receipt real printer 215 only needs to support the receipt printing functions. Other functions of a hybrid printer are implemented virtually. The primary virtual hybrid printer function implemented is the printing to the slip or document printer (e.g., 110 in FIG. 1) that would typically be found in a hybrid printer. If the application 125 requests that the function of endorsing a check payment be performed, the virtual hybrid printer captures that endorsement print data from the application in the form of print commands to the slip printer device and converts it to an image that is then superimposed on the back or reverse side image. Since basic check scanner typically only capture the front of the check, the reverse side image can be created using, for example, any common technique such as applying text characters to a bit oriented image of the check being accepted for payment. The VCHECK Scanner Control 315 determines if the Check Scanner device 220 can capture both the front and reverse side of the check and conveys this information in the images 365 that it stores of the check being accepted for payment. Additionally, virtual hybrid printer configuration parameters can be used to define if the application will request via the VCHECK Control 315 that the back of the check be scanned and captured or if the back of the check image is to be created by the VPOS Printer Service 330 prior to superimposing the endorsement text onto the back of the check image.

In the FIG. 3 embodiment, the real printer functions implemented by the VPOS Printer control 310 include requests to print on the receipt printer 215. Such printing functions include text line printing, bitmap printing, barcode printing, and paper cut and feed functions. The application 125 would make a request to the VPOS Printer Control 310, which could be in the form of method call. The application 125 could receive information for the control of the receipt printer in the form of properties. The application 125 can also receive events from the VPOS Printer Control 310 for certain printer changes in state e.g., cover open, print complete, printer error, etc. The VPOS Printer Control 310 passes this information to/from the Printer Service 325 that performs the actual communication to/from the receipt printer 215, or to/from the Virtual Printer Service (VSLP) 330 that can pass information such as the check image. As shown in the FIG. 3 embodiment, the VPOS Printer Control 310 interfaces with the printer service 325 for operation of the receipt printer 215; and with the VSLP Printer Service 330 for the virtual slip printer functions, which include the endorsement of a check payment.

In an exemplary embodiment, some of the function request (Methods) that the VPOS Printer Control 310 receives from the application 125 can include the UnifiedPOS requests:
PrintNormal(Receipt Station, Data)—directed to the real printer;
BeginInsertion(timeout) and EndInsertion( )—insertion of the check is simulated if the check has been scanned, else the virtual check scanner is activated to capture the check image;
PrintNormal(Slip Station, Data)—directed to the virtual printer (check image file); and
BeginRemoval(timeout) and EndRemoval( )—removal of check is simulated.

The VPOS Printer Control 310 works with the check image collected by the VCHECK Scanner Control. For example, the VPOS Printer Control 310 receives from the application 125, and re-directs print requests for the SLP printer to the VSLP Printer Service 330. The VSLP Printer Service 330 can create an endorsement image by utilizing the text present in the SLP print request. The VSLP Printer Service 330 can then retrieve the original check image from, for example, Images 365 and merge it with the endorsement image using known techniques, such as the merging of text characters and a bit oriented image.

In an exemplary embodiment, the properties that the VPOS Printer Control 310 provides to the application 125 can include:

1. The receipt printer properties (CapRecxxxxx and Recxxxxx), which are supplied by the POSPrinter Service 325 for the receipt printer 215. These properties define the hardware capabilities of the printer, and are used to control the receipt printer 215 operations that the application can use.

2. Slip Printer (“SLP”) properties (CapSlpxxxxx and Slpxxxxx) that are set according to the basic settings for the virtual slip printer desired to be supported. These properties are used to control the virtual slip printer operations that the application can perform. Since the operations of the virtual slip printer are not related to a hardware device, in a basic embodiment of the present invention, only the basic capabilities would be supported. The SLP properties are supplied by the VSLP Printer Service 330. The VSLP Service 330 sets these properties to define the capabilities and operating properties of the virtual device.

The VCHECK Scanner Control 315 is a control that, in an embodiment, implements the UnifiedPOS check scanner interface. In this embodiment, the check image scanner 220 is the physical device, which interfaces with the Check Scanner Service 335. The virtual functions of the VCHECK Scanner Control include interfacing to the VPOS Printer Control 310 and the VMICR Control 320. This interface allows a single imaging of a check to supply both image and MICR data to all the virtual controls. Thus, when a check image is scanned by the check image scanner 220, the image is preserved, and is available for the VPOS Printer Control 310 for check endorsing. As will be recognized by those skilled in the art, the particular communication method depends on the operating system and method of implementation. The MICR data is obtained from the check image. That data is available, from for example, a file, to the VMICR Control 320 when the application initiates a MICR read function.

In an exemplary embodiment, some of the function request (Methods) that the VCHECK Scanner Control 315 receives from the application 125 can include the UnifiedPOS requests:
BeginInsertion(timeout) and EndInsertion( )—insertion of the check is simulated if the check has been scanned, else the virtual check scanner is activated to capture the check image;
RetrieveImage(CropAreaID)—Retrieves check scan image from the image scanner device and places it in the Image Data property;
StoreImage(CropAreaID)—Stores the image in the virtual device memory (operating system file) for use by the VPOS Printer control and the VMICR control; and
BeginRemoval(timeout) and EndRemoval( )—removal of check is simulated.

In an exemplary embodiment, the properties that the VCHECK Scanner Control 315 provides to the application 125 can include: The properties provided by the VCHECK Scanner Control 315 to the Application 125 can typically be the properties provided by the Check Scanner Service 335 that define the real check image scanner device.

The Check Image Scanner properties are provided by the real Check Scanner Service 335, and are those for the physical Check Image Scanner 220. Commonly, these properties are either fixed or set when the service is installed and define the Check Image Scanner hardware features.

The VMICR Control 320 is a control that, in an embodiment, implements the UnifiedPOS. In this embodiment, the MICR is a virtual device, which in effect is simulated by the embodiment shown in FIG. 3 via the VMICR Control 320 interfacing with the VCHECK Scanner Control 315 via the VMICR Service 340. If the VMICR Control 320 is called by the Application 125 before either the Application 125and/or the VCHECK Scanner Control 315 has requested a check image via the VCHECK Scanner Control 315, the VMICR Service 340 will request the VCHECK Scanner Control 315 to activate the Check Image Scanner to obtain a check image. The VCHECK Scanner Control 315 can store the received check image in images 365. The VMICR Service 340 can then retrieve the check image and decode the MICR data from the check image. If the Application 125 has requested a check image before requesting the MICR data, the VMICR Service 340 can retrieve the check image and decode the MICR data from the received check image. This interfacing allows a single imaging of the check to supply image and MICR data to all the virtual controls. Thus, when a check image is scanned by the Check Image Scanner 220, the image is preserved by the VCHECK Scanner Control in Images 365, and is available, as noted above for example, for the VMICR Service 340 and for the VPOS Printer Control 310 for check endorsing. The MICR data is obtained from the check image. That data is available and is stored, in for example, the MIRC properties. It is available to, for example, the VMICR Control 320 when the application initiates a MICR read function. In an exemplary embodiment, some of the function request (Methods) that the VCHECK Scanner Control 315 receives from the application 125 can include the UnifiedPOS requests:
BeginInsertion(timeout) and EndInsertion( )—insertion of the check is simulated if the check has been scanned, else the virtual check scanner is activated to capture the check image. On the EndInsertion( ) the MICR data in placed into the MICR data properties and either a data or error event is signaled to the application; and
BeginRemoval(timeout) and EndRemoval( )—the removal of check is simulated.

In an exemplary embodiment, the properties that the VCHECK Scanner Control 315 provides to the application 125 do not include the common MICR properties, but only includes the properties and methods from the Check Scanner Service 335. The properties that the VMICR Control 320 provides to the application 125 can include the virtual capabilities of the virtual MICR device that preferably reflect those of a physical MICR.

In an embodiment, such as shown in FIG. 3, the Printer Service 325 is a service that can implement UnifiedPOS for a POS Printer. For example, it can provide the interface to the physical Receipt printer 215. As such, the Printer Service 325 would preferably provide all of the Methods and Properties for a POS Printer device. However, the VPOS Hybrid Printer Control 310, provides receipt printer properties and methods from the POS Printer Service 325 and Slip Printer properties and methods from the VSLP Printer Service 330 to the application 125.

In an embodiment, such as shown in FIG. 3, the VSLP Printer Service 320 is a service that can implement the UnifiedPOS for a POS Printer. In the FIG. 3 embodiment, it is a service for a virtual device since there is no physical slip printer. The VPOS Printer Control 310 receives the printer properties and method calls made by the application 125. The properties and methods identify to which print station the call is directed. The VPOS Printer Control 310 re-directs all slip printer methods and properties to this service to provide a virtual slip printer operation that provides the desired physical slip printer functions. However, the VPOS Printer Control 310 could provide only selected ones of the slip printer properties and methods from the VSLP Printer Service 330 to the application 125.

In an embodiment, such as shown in FIG. 3, the Check Scanner Service 335 is a service that can implement the UnifiedPOS for a check image scanner. For example, it can provide the interface to the physical Check Image Scanner 220. It can be, for example, a real service, a virtual service, or a process. The Check Scanner Service 335 would preferably provide the Methods and Properties for Check Scanner Service 335. However, the VCHECK Scanner Control 315, could only provide selected check image scanner properties and methods to the application 125.

In an embodiment, such as shown in FIG. 3, the VMICR Service 340 is a service that can implement the UnifiedPOS for a MICR reader. In the FIG. 3 embodiment, it is a service for a virtual device since there is no physical MICR reader. The VMICR Control 320 directs all MICR methods and properties to this service to provide a virtual MICR operation that provides the desired physical MICR functions. However, in this example, the VMICR Control 320 could provide only selected ones of MICR properties and methods from the VMICR Service 320 to the application 125. For example, software is called by the application 125 within the VMIRC Control 320 when a MICR operation is desired. That software, in turn, calls or invokes, and/or transfers control to the VMICR Service 340, which tells the VMICR Control 320 what to do (i.e., supplies the instructions on how to command the VMICR Service 340.

In an embodiment, such as shown in FIG. 3, Images 365 represents check images. The Images 365 could be stored on or in any storage device or location. It could be in a file or files, or remote file, or be in a local or remote database. It is preferably in the POS terminal, but could be on a server or any other storage device or location. The stored Images 365 could be of the front and back of checks that are captured by the VCHECK Scanner Control. The Images 365 can be modified by any convenient technique, such as noted above modifying a bit image, by the VSLP Printer Service when the application 125 indorses the back of the check. The check endorsement text can be supplied by the application 125 via, for example, store configuration parameters that can define the template for a check endorsement and the current transaction information. It is converted to an image and superimposed onto the image of the back of the check. The check images can be retained in Images 365 and returned to the application 125 when requested, via for example, application interfaces that allow access to the images, so that they may be printed or used in the check handling process as needed by the application 125.

In an embodiment such as shown in FIG. 3, the application 125 can be a point of sale application and part of the virtual hybrid printer system. In a preferred embodiment, it can control the transaction sequence in processing a check when tendered as a form of payment. Further the application 125 accepts a check as a form of payment, and can use the VMICR Control 320 to obtain the MICR data that is printed on the check. The application 125 can utilize the VCHECK Control 315 to obtain an image of the check that is tendered for payment, and can use the VPOS Printer Control 310 to print endorsement text on the image of the back of the check. In the illustrated exemplary embodiment, the application 125 can use the VPOS Printer Control 310 to print the transaction data and the images of the front and back (e.g., endorsement information) of the check tendered on the receipt. The application 125 can also use an authorization service to process the tendered check as an electronic funds transfer (EFT).

A further embodiment of the invention is shown in FIG. 3. The FIG. 3 exemplary embodiment illustrates that an image process (i.e. executable program) may be used to capture a check image using the check image service 335 and the check image scanner 220 as the image capture device. This configuration allows for flexible managing and controlling of an imaging device for the purpose of capturing an image of a check that is tendered for payment. This facilitates the use of imaging devices to produce a less costly transaction processing apparatus.

FIG. 3a is a further embodiment of the invention that illustrates a configuration that allows the use of a web camera or other type imaging device 360 as the check scanner 220. This is accomplished, in the FIG. 3a embodiment, by a configuration of the VCHECK scanner control 315 that uses a virtual VCHECK scanner service 355. The VCHECK scanner service 355 utilizes an image process (i.e. executable program) as part of the service to manage the image device and capture the check image. The image process program may use OPOS and a check scanner service or other interface software to access a check scanner or imaging device.

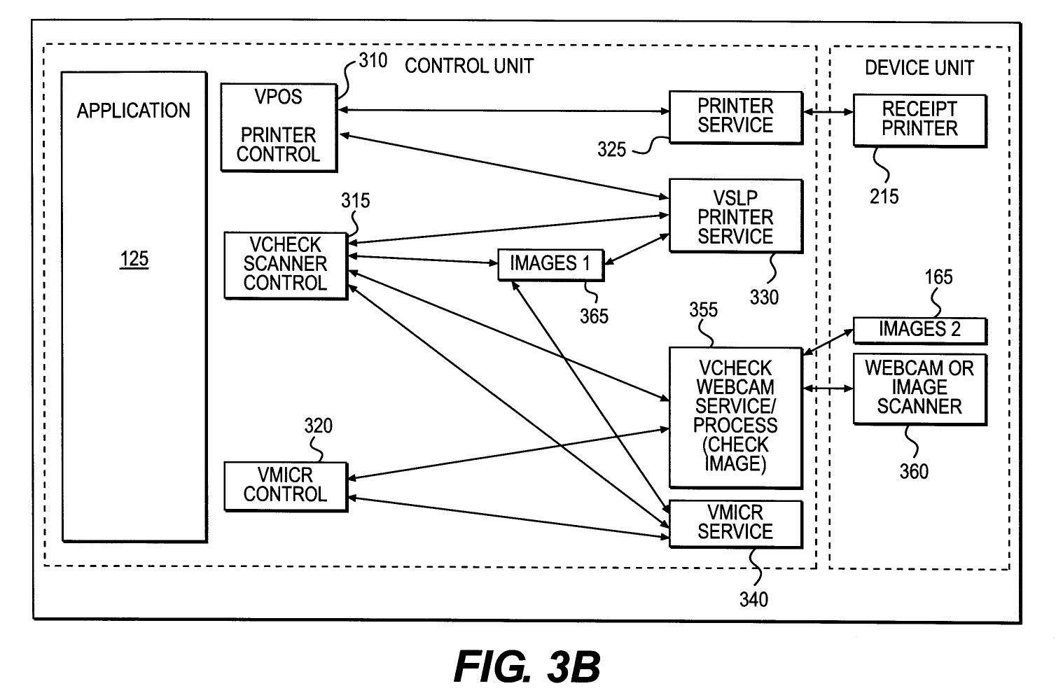

FIG. 4 is a flow diagram example of a possible application payment sequence that only prompts for the MICR data from a check and then endorses the check when payment is complete.

FIG. 5 is a flow diagram example of a possible application payment sequence where check truncation is used for an electronic funds transfer (EFT). The MICR data and the check image are both needed in this sequence.

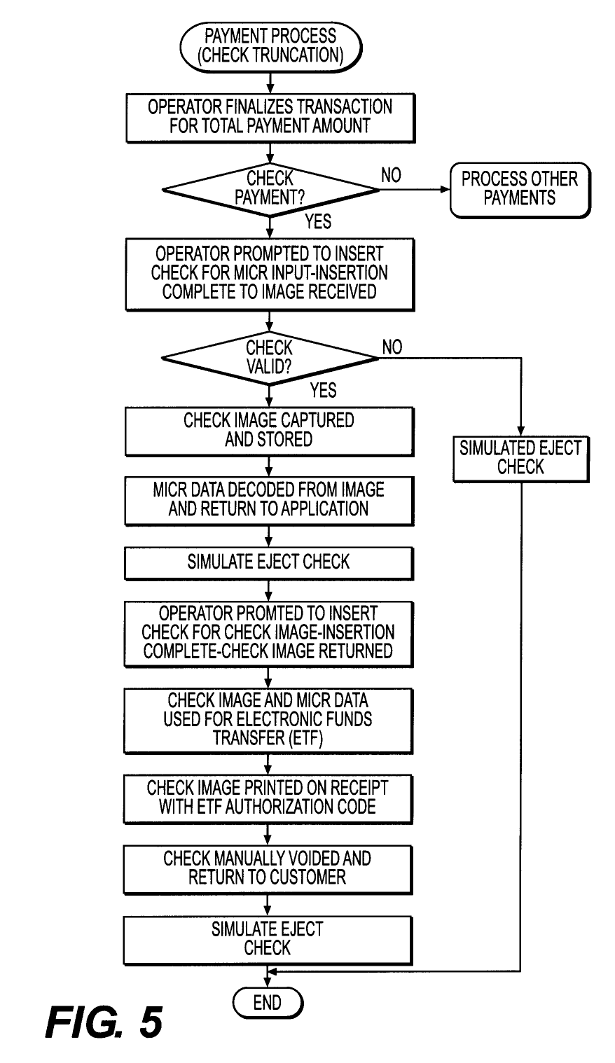

FIG. 6 is a flow diagram example of a future feature of the Virtual Hybrid Printer where the “Pay To” and “Amount” text fields on the front of the check image are superimposed on the original check image.

For point of sale applications that use the full function hybrid printer, including, for example, a check image scanner, embodiments of a virtual hybrid printer in accordance with the present invention offer a lower cost option to a physical hybrid printer. Moreover, for POS applications that use a hybrid printer without a check imaging capability, embodiments of a virtual hybrid printer in accordance with the present invention offer a less expensive way to achieve the capabilities of a full function hybrid printer. And, for POS applications that use only a single printer, embodiments of a virtual hybrid printer in accordance with the present invention offer a less expensive way to add the full check processing capabilities of a full function hybrid printer.

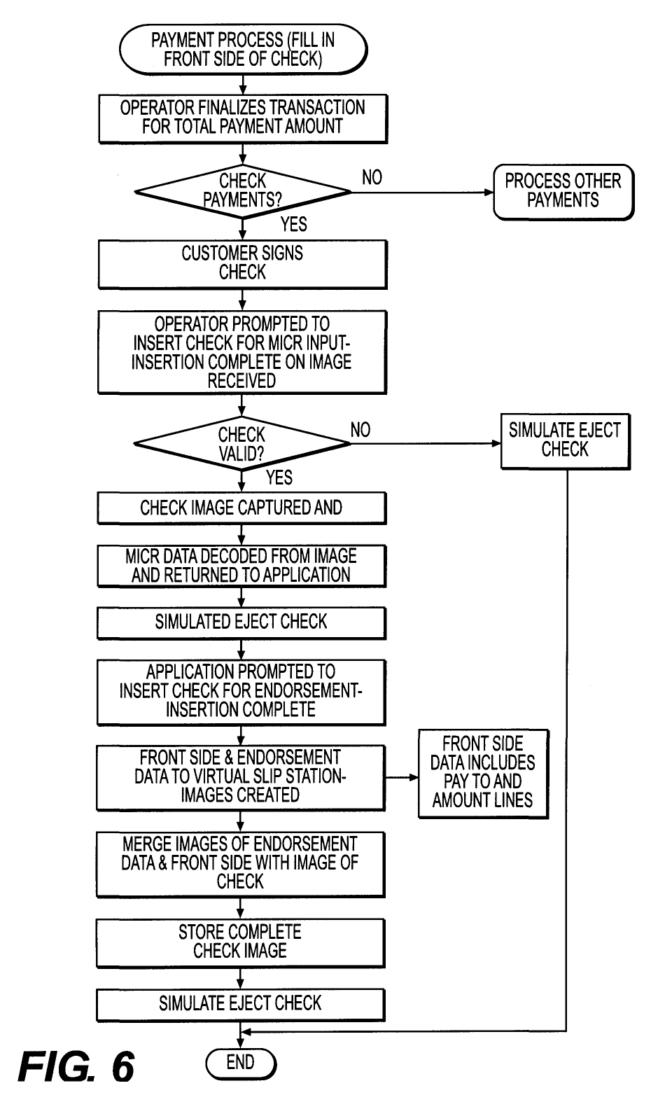

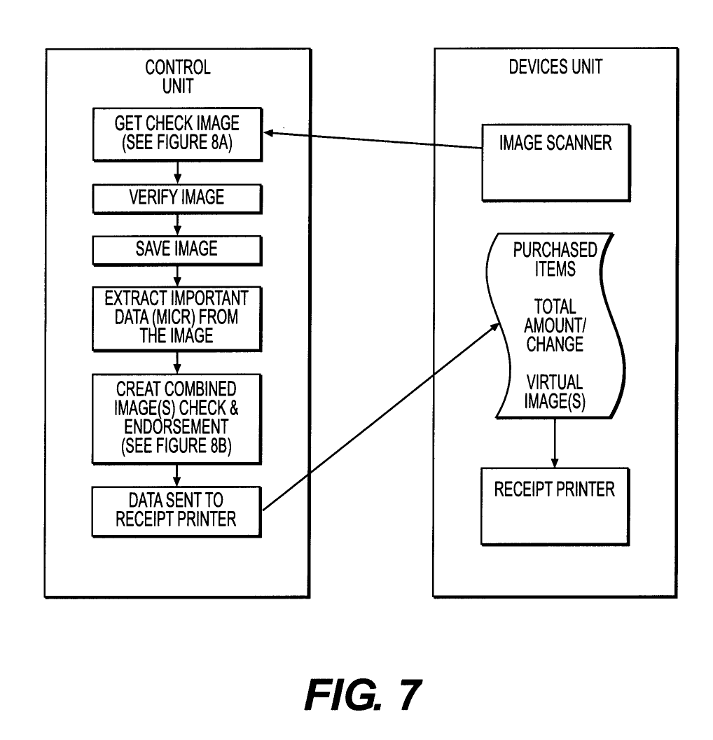

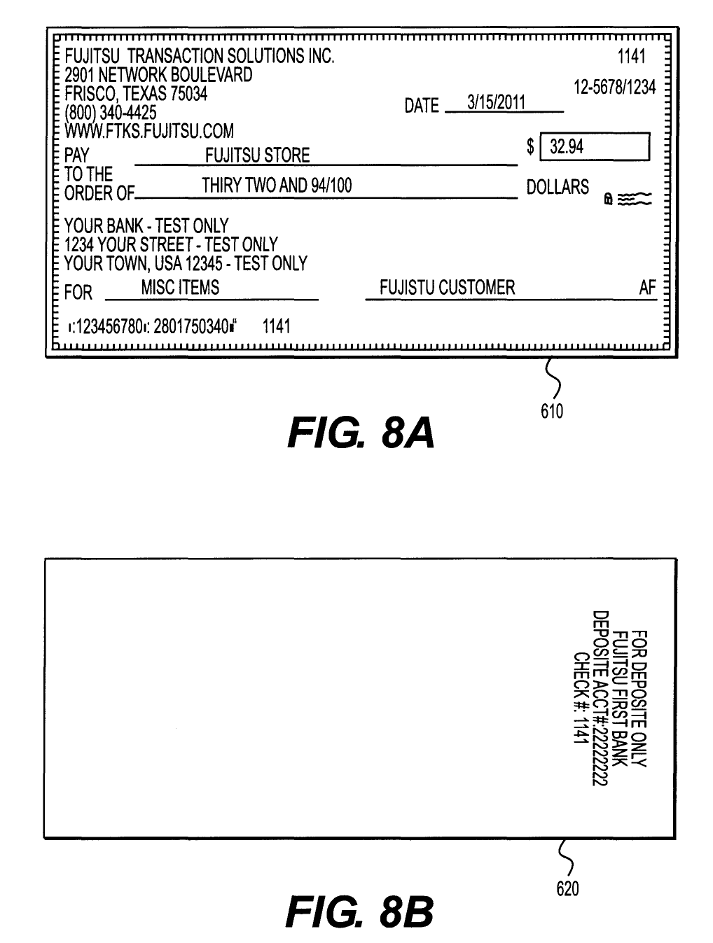

FIG. 7 is an example flow diagram of an embodiment of the present invention. Generally FIG. 7 illustrates an exemplary sequence to capture a check image and to create an endorsed image. In the example embodiment, the control unit block encapsulates the Application, the software of the Virtual Hybrid Printer, storage media for the images, and interface software and device drivers needed to communicate with the devices. The devices unit encapsulates the physical devices that are present in the system. More particularly, the figure illustrates a sequence of receiving a check image 610 (e.g., FIG. 8a), extracting the MICR data, and generating the check endorsement image 620 (e.g., FIG. 8b). The Image scanner 510 and the Receipt Printer 520 are shown as part of the Devices Unit 500, but need not be.

FIG. 8 illustrates a captured check image 610, and a generated image of the backside of a check 620 with the check endorsement text added.

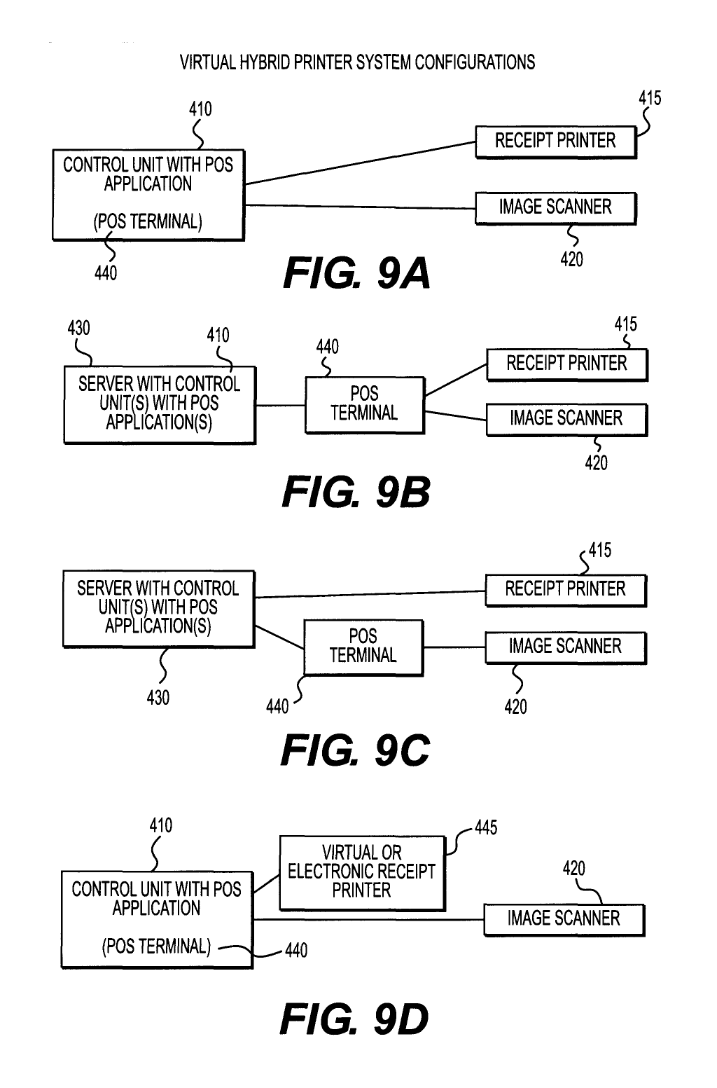

FIG. 9 illustrates various exemplary configurations of embodiments of the present invention. FIG. 9(a) is a configuration where the Control Unit 410 resides in the physical POS Terminal 440. The Receipt Printer 415 and the Image Scanner 420 are connected to the POS Terminal 440. FIG. 9(b) is a configuration where the Control Unit(s) 410 resides in a Server 430 and the POS Terminal(s) 440 are connected to the Server 430. The Receipt Printer 415 and the Image Scanner 420 are connected to the POS Terminal 440. FIG. 9(c) Illustrates a Server 430 system where the Control Units 410 reside. The Receipt Printer is connected to the Server 430, but the Image Scanner 420 is connected to the POS Terminal 440. FIG. 9(d) illustrates a typical configuration but the Receipt Printer 445 is a virtual or electronic receipt device instead of a physical printer. The Image Scanner 420 is connected to the POS Terminal 440

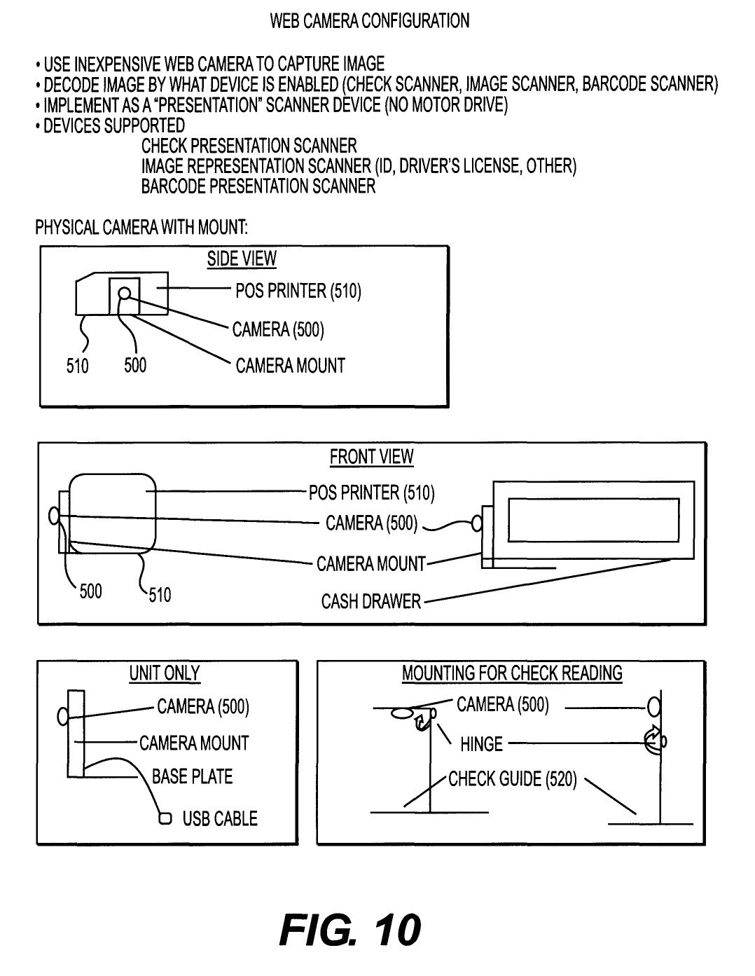

FIG. 10 illustrates exemplary hardware configurations for the use of a web camera 500 or a similar device as the image scanning device for the check image as well as an image scanning device to replace multiple other POS devices such as a barcode scanner and a basic image scanner. Some exemplary of camera mountings are also shown in the figure. A brief description of some devices that could be replaced by the lower cost imaging device are given below.

### Check Scanner:

As an example, when the application prompts for an item such as a check and enables the Check Scanning device 500, the operator “presents” the item by holding the item in front of the camera 500 until the application proceeds or an error indication is given. The check scanner software attempts to retrieve a valid MICR code from a snapshot of the image. After a preset time if no MICR data is retrieved from the image an error is returned to the application.

### Barcode Scanner:

In an example embodiment, when the application prompts for an item such as a barcode and enables the Barcode Scanning device 500, the operator “presents” the item by holding the item in front of the camera 500 until the application proceeds or an error indication is given. The barcode scanner software attempts to retrieve a valid barcode from a snapshot of the image. After a preset time if no barcode data is retrieved from the image an error is returned to the application.

### Image Scanner (Future Capability):

In an example embodiment, when the application prompts for an item such as an ID, drivers' license, or other document and enables the Image Scanning device 500, the operator “presents” the item by holding the item in front of the camera 500 until the application proceeds or an error indication is given. The image scanner software will use the snapshot of the image. After a preset time if no image data is retrieved an error is returned to the application.

1. A virtual hybrid printer operatively connectable for communications with an application, said virtual hybrid printer comprising:
a control unit;
a receipt printer device operatively connected to the control unit and constructed and arranged to print a receipt in response to a request from the application;
a camera operatively connected to the control unit to provide image data based on an image of a check;
a virtual magnetic information character recognition service, constructed and arranged to communicate with the application, and to provide magnetic information character recognition data to the application based on the image data provided by the camera.

2. A virtual hybrid printer according to claim 1, further comprising:
a virtual slip printer service, operatively connected to the control unit and constructed and arranged to communicate with the application so as to provide a virtual slip printing service to the application.

3. (canceled)

4. A virtual hybrid printer according to claim 1, wherein the control unit is operatively connectable to a payment validation system; and further comprising:
a point of sale application; and
an application interface constructed and arranged to interface the physical printer, the camera, and the virtual magnetic information character recognition service.

5. A virtual hybrid printer according to claim 4, wherein the point of sale application is constructed and arranged to accept a check as a form of payment, to validate the check, to provide a check endorsement; and to obtain a check image suitable to complete a transaction with the payment validation system.

6. A virtual hybrid printer according to claim 4, further comprising:
a check validation method operatively connected to validate a check based on the magnetic information character recognition data; and
an electronic funds transfer method operatively connected to complete a transaction based on a check image.

7. A virtual hybrid printer according to claim 4, further comprising:
a virtual printer interface software structured and arranged to print a receipt;
a virtual printer interface software structured and arranged to print a slip;
a virtual check scanner interface software structured and arranged to obtain check image data from the camera; and
a virtual magnetic information character reader interface software structured and arranged to obtain magnetic information character data from the virtual magnetic information character recognition service based on the image data provided by the camera.

8. A virtual hybrid printer according to claim 2, wherein the virtual slip printer service is structured and arranged to accept and process a print request.

9. A virtual hybrid printer according to claim 7, wherein the virtual check scanner interface is structured and arranged to create a virtual check image based on check image data from the camera, and locally storing the virtual check image.

10. A virtual hybrid printer according to claim 7, wherein the virtual magnetic information character reader interface software is structured and arranged to process requests from the point of sale application for to retrieve magnetic information character data, to initiate a check scan, to create a virtual check image, to locally store and retrieve the virtual check image, to extract magnetic information character data from the virtual image and providing it to the point of sale application.

11. A virtual hybrid printer image processing method for processing image data acquired from an image scanning device in response to commands issued by a point of sale application, the method comprising:
scanning image data using a scanning device;
creating virtual image from the scanned image;
locally storing virtual image data;
merging text image data with virtual image data;
retrieving the virtual image data; and
processing the virtual image data according to type of image.

12. A virtual hybrid printer image processing method comprising:
scanning a customer signed check image via an image scanning device;
creating virtual check image from the scanned check image;
storing virtual check image in a storage media;
extracting magnetic image character recognition data from the virtual check image;
sending magnetic image character recognition data to a point of sale application;
retrieving the virtual check image and adding endorsement to the virtual check image in accordance with commands from a point of sale application;
retrieving completed virtual check image in accordance with commands from a point of sale application for an electronic funds transfer;
retrieving completed virtual check image in accordance with commands from a point of sale application for printing on the receipt printer; and
printing a receipt on a physical receipt printer.
